(19) United States
(12) Patent Application Publication
(10) Pub. No.: US 2003/0012918 A1
(43) Pub. Date: Jan. 16, 2003

(54) Insulation system, insulation method and use insulation system

(76) Inventors: Tom W. Torbal, Oslo (NO); Eivind Robert Oen, Fyllingsdalen (NO)

Correspondence Address: BURNS DOANE SWECKER & MATHIS L L P, POST OFFICE BOX 1404, ALEXANDRIA, VA, 22313-1404, US

(21) Appl. No.: 10/181,368

(22) PCT Filed: Jan. 18, 2001
(86) PCT No.: PCT/NO01/00017

(30) Foreign Application Priority Data
Jan. 20, 2000 (NO) 2000-0290

(51) Int. Cl. B32B 1/04

(52) U.S. Cl. 428/69; 428/36.9

(57) ABSTRACT

A thermal insulation system consisting of air or gas filled channels is described, where the channels are filled at the installation site. Insulation methods and the use thereof are also described

The present invention relates to a thermal insulation system comprising an insulating material having channels, where the channels are filled with air or gas at the site where the insulation system is to be used.

The good heat insulating ability of stationary air is well-known and needs no further explanation here. To make use of this property when insulating hot or cold surfaces from the surroundings, these surfaces must be covered in such a way that they are enveloped by stationary air.

The usual method of insulation is to lag with a porous material that contains as much stationary air as possible. A better insulation is obtained by increasing the thickness of the porous material. One of the disadvantages of such porous air-containing materials is that when subject to mechanical or chemical strain they might lose some of or the whole of the enclosed air volume which will result in a considerable decrease in their insulating ability, and this in turn will lead to an increase in financial costs owing to loss of heat or cold.

Another drawback of this type of insulation is that in order to obtain sustained mechanical stability, it is often necessary to manufacture, transport and store such insulating materials in an air-filled state. This entails the storage and transport of large volumes of air, which leads to undesirable financial and environmental costs.

The use of tubular insulating units consisting of a plurality of small channels for the insulation of gas pipes is known from GB Patent 1 283 329. These units are installed and secured inside a pipeline that is to be insulated. All the channels are open at one end and closed at the other end and arranged parallel to the pipeline. Thus, the units come in direct contact with the gas flowing in the pipe, which means stringent demands are made with respect to the selection of material. The system works only for gas pipes, and as the insulation is placed inside the pipe the diameter of the pipe will be of considerable size, which means that the said problems concerning transport and storage are not solved.

NO Patent 79678 describes a cellular thermal insulation where each cell consists of a frame wholly or partially enveloped by insulating fibres. The stationary air for insulation is obtained by arranging the number of cells necessary in each case inside a cavity. The cells occupy a large amount of space and there is no description of how they might be compressed during transport or storage.

Accordingly, the object of the present invention is to provide an insulation system which in specific areas of use solves the aforementioned problems associated with the known insulation systems.

The present invention thus provides an insulation system consisting of channels provided in a mat or other flexible material, and the system is characterised in that the filling of the channels with gas or air takes place at the installation site of the insulation system, wherefore the channels may be equipped with one or more valves.

The present invention further provides an insulation method, and this method is characterised in that it comprises the following steps:

a) making an insulating mat comprising one or more non-filled channels;

b) transporting the insulating mat to the site of use;

c) filling the channels in the insulating mat with air or gas using compressed air or pressurised gases;

d) placing the insulating mat around/on/in the object to be insulated.

Furthermore, the present invention comprises the use of the insulation system and the method for insulating machine parts, tanks, pipes and parts in communication with pipes, and also for insulating buildings and structures on ships or offshore platforms.

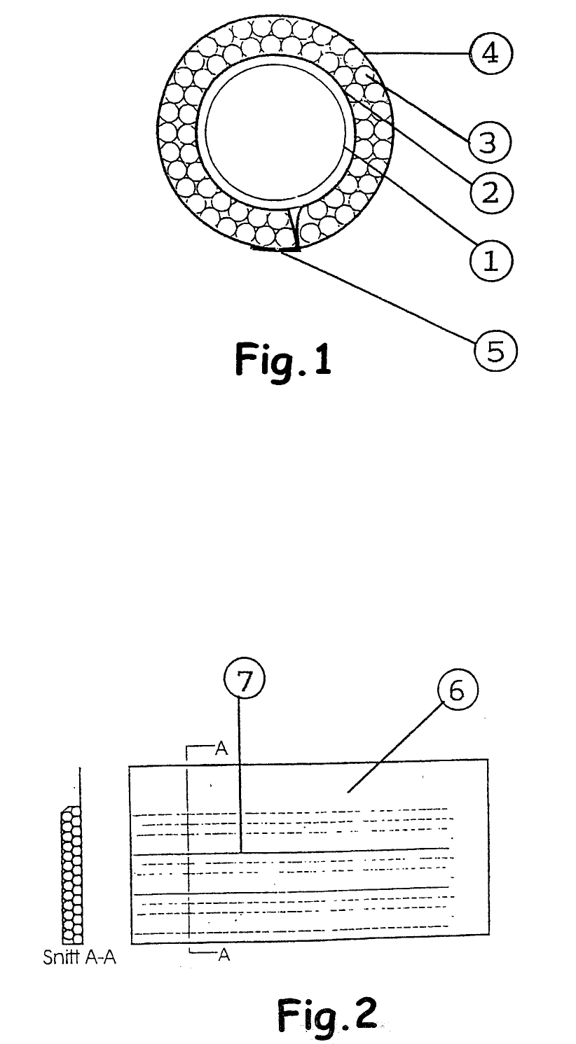

The present invention will now be described in more detail with reference to FIGS. 1-6 wherein:

FIG. 1 is a cross-sectional view of a pipe that has been insulated using the insulation system of the present invention.

FIG. 2 shows an unfolded insulating mat according to the invention.

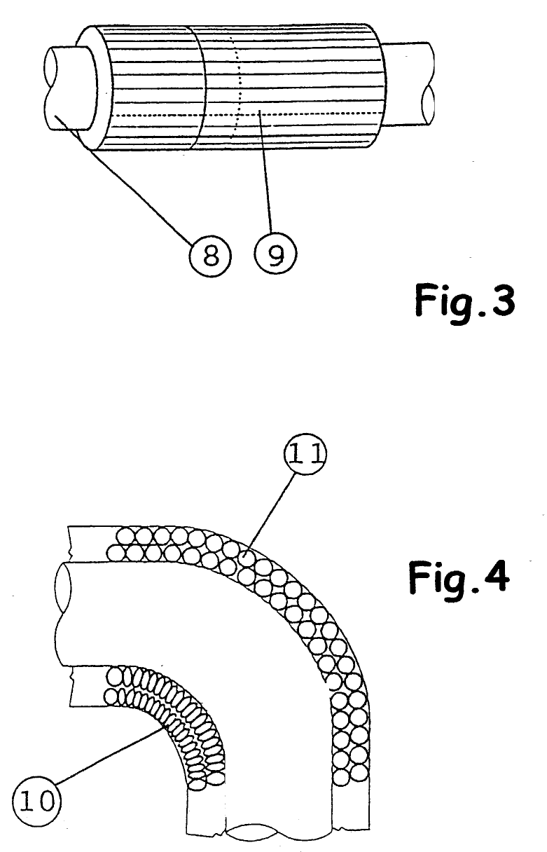

FIG. 3 shows an insulating sleeve according to the invention placed around a pipe.

FIG. 4 depicts the insulating material of the invention placed around a pipe bend.

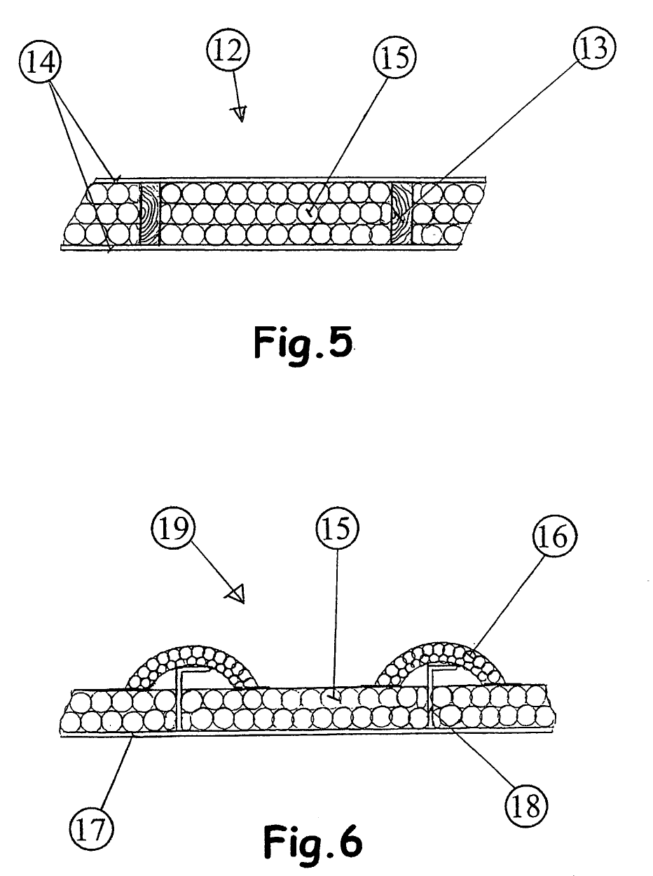

FIG. 5 is a cross-sectional view of a wall or storey partition of wood insulated using the insulation system of the invention.

FIG. 6 is a cross-section view of a horizontal or vertical partition (deck/bulkhead) of steel or aluminium insulated using the insulation system of the invention.

The present invention has been especially designed for use in insulating machine units. tanks, pipes and parts in communication with pipes.

The phrase “parts in communication with pipes” should be understood to mean, for example, valves, connectors, metering devices, pumps and the like.

The insulation system according to the present invention consists of a number of channels running parallel to one another. The channels may lie fairly close to one another, thereby forming a mat, or they are fastened to a mat. One possible embodiment of such a mat 6 is shown in FIG. 2.

FIG. 1 shows an embodiment of the invention where a mat according to FIG. 2 has been placed around a pipe 1 that is to be insulated. The inside face 2 of the mat holds the channels 3 in place against the pipe 1. The outside face 4 of the mat is made of a material that withstands mechanical stress without the channels 3 “puncturing”. The inside face 2 can be brought to the outside so that it overlaps the outside face 4. A fastening means 5 ensures that the insulating mat remains in the desired position. The fastening means 5 may, for example, consist of an adhesive, a weld, a touch-and-close fastener or another type of fastening means. In addition, the insulating material, once in position, can be secured using strapping (not shown).

FIG. 3 shows another embodiment of the invention. An insulating sleeve 9 consisting of channels according to the invention has been placed on a pipe 8. The length of such insulating sleeves is variable, but for practical reasons it would be an advantage if they were standardised. The insulating sleeve 9 may consist of an insulating mat 6 according to FIG. 2.

The gas or air-filled channels in the insulation system can extend in any chosen direction. In the insulation of pipes, they can. for example, extend in the longitudinal direction of the pipe, see FIG. 3, or transverse to the longitudinal direction, see FIG. 4. FIG. 4 shows how the diameter of the individual air or gas-filled channels adapts to a typical pipe bend. On the inside 10 the channels become packed together without closing, so that they fit into the bend. On the outside 11, the channels retain their original shape which ensures good insulating effectiveness.

FIG. 5 shows the insulation of a wall or a storey partition 12 where the insulating mat 15 is laid between studs or joisting 13 and between wall, floor or ceiling panels 14.

FIG. 6 shows the insulation of a bulkhead or deck 19, where the insulating mat 15 is placed on a steel or aluminium plate 17. When filled with air or gas. the insulating mat 15 is pressed against a brace or beam 18 so that it remains in the desired position. Another type of securement may, for example, consist of adhesive bonding to the steel or aluminium plate 17. An insulating mat 16 is placed over the brace or beam 18, and the manner of fastening the insulating mat 16 to the insulating mat 15 may be to use adhesive bonding, welding, a touch-and-close fastener or another type of fastening means.

The selection of material for making the insulation system is a matter of free choice and can be adapted to the demands made on the whole arrangement with regard to mechanical strength, fire safety and the like.

The insulation system according to the invention has a positive draining effect as regards condensation because the surface of the system is smaller and more readily accessible than the known porous, fibrous insulating materials.

The insulation system according to the invention is transported to the site of use in compressed form and is not filled with air or gas until it is at the site. Thus, the previously mentioned problems associated with the known insulation systems are obviated. The system can be filled with air or gas via a valve arranged on the insulating mat. In addition, the valve may be equipped with a manometer so that the pressure in the insulation system can be monitored, thus ensuring that any defects are discovered promptly.

1. An insulation system consisting of channels provided in a mat or other flexible material, characterised in that the filling of the channels with gas or air is done at the installation site of the insulation system. wherefore the channels may be equipped with one or more valves.

2. An insulation system according to claim 1, characterised in that the channels are filled with air.

3. An insulation system according to claim 1, characterised in that the channels are filled with gas, preferably argon.

4. An insulation system according to any one of claims 1-3, characterised in that the valves are connected to a pressure monitoring system which ensures constant insulating effectiveness.

5. An insulation method, characterised in that it comprises the following steps:
a) making an insulating mat comprising one or more non-filled channels;
b) transporting the insulating mat to the site of use;
c) filling the channels in the insulating mat with air or gas using compressed air or pressurised gas;
d) placing the insulating mat around/on/in the object to be insulated.

6. A method according to claim 5, characterised in that the placing of the mat d) is done before the filling of the channels c).

7. A method according to claim 5, characterised in that the channels are filled with gas, preferably argon.

8. A method according to claim 5, characterised in that the channels are filled with air.

9. Use of the insulation system according to any one of claims 1-4 or any one of the methods according to claims 5-8 for insulating machine parts, tanks, pipes and parts in communication with pipes.
